(19) United States
(12) Patent Application Publication
(10) Pub. No.: US 2026/0116667 A1
(43) Pub. Date: Apr. 30, 2026

(54) Article Transport Vehicle

(71) Applicant: Daifuku Co., Ltd., Osaka-shi (JP)

(72) Inventors: Yoshifumi Yasuda, Hinocho (JP); Kazuki Ogawa, Hinocho (JP); Naoto Hamada, Hinocho (JP)

(21) Appl. No.: 19/373,996

(22) Filed: Oct. 30, 2025

(30) Foreign Application Priority Data
Oct. 31, 2024 (JP) 2024-191939

(51) Int. Cl. B65G 17/12; B65G 17/38

(52) U.S. Cl. CPC B65G 17/12; B65G 17/38; B65G 2812/02069

(57) ABSTRACT

An article transport vehicle includes a travel unit; an article holder; two lift mechanisms each including a roller chain and configured to raise and lower the article holder; and a guide mechanism configured to guide the article holder in a lifting direction. The guide mechanism includes a guide rail held by the travel unit and extending along an up-down direction; a plurality of rollers configured to roll in contact with the guide rail; a roller support supporting the plurality of rollers, and a joint mechanism joining the roller support to the article holder. The plurality of rollers are disposed in such a manner as to restrict movement of the roller support in a first direction and a second direction while allowing the roller support to move in the up-down direction relative to the guide rail.

### CROSS-REFERENCE TO RELATED APPLICATION

This application claims priority to Japanese Patent Application No. 2024-191939 filed October 31, 2024, the disclosure of which is hereby incorporated by reference in its entirety.

### BACKGROUND OF THE INVENTION

### FIELD OF THE INVENTION

The present invention relates to an article transport vehicle equipped with a lift mechanism configured to raise and lower an article holder.

### DESCRIPTION OF RELATED ART

JP 2011-115763A discloses an article transport vehicle that includes a lift mechanism (32) having a lift arm (32A) and a drive arm (32B) and is configured to raise and lower an article holder (33) for holding an article (W). This article transport vehicle changes the orientations of the article (W) and the article holder (33) to a front-downward inclined orientation and a rear-downward inclined orientation by rotating a drive sprocket (54) to rotate a suspension support shaft (46) together with a driven sprocket (53) via a roller chain (55) and oscillating a suspension member (47).

In the article transport vehicle of JP 2011-115763A, the article holder is held by the lift arm. Here, for example, it is conceivable to hold the article holder in a suspended manner using a roller chain instead of the lift arm in order to, for example, simplify the article transport vehicle. However, holding the article holder in a suspended manner using a roller chain may damage the roller chain if a load in a direction different from a winding direction, e.g., a large load in a direction parallel to a winding shaft is applied to the roller chain.

### SUMMARY OF THE INVENTION

It is desirable to realize an article transport vehicle that facilitates reducing loads acting on the roller chain.

An article transport vehicle according to the present disclosure includes a travel unit configured to travel along a travel path; an article holder configured to hold the article; two lift mechanisms suspending and holding the article holder and configured to raise and lower the article holder; and at least one guide mechanism configured to guide the article holder in a lifting direction, each of the two lift mechanisms including: a roller chain; a drive sprocket configured to wind and unwind the roller chain; and a chain joint joining the roller chain and the article holder to each other, the chain joints of the two lift mechanisms being separated from each other in a second direction as viewed along a first direction, the first direction and the second direction being orthogonal to each other as viewed vertically, the drive sprocket having a rotational axis extending along a direction intersecting an up-down direction, the guide mechanism including: a guide rail held by the travel unit and extending along the up-down direction; a plurality of rollers configured to roll in contact with the guide rail; a roller support supporting the plurality of rollers; and a joint mechanism joining the roller support to the article holder, the plurality of rollers being disposed in such a manner as to restrict movement of the roller support in the first direction and movement in the second direction, while allowing the roller support to move in the up-down direction relative to the guide rail, the joint mechanism joining the roller support to the article holder in such a manner as to allow the roller support to oscillate about an oscillation axis extending along the first direction, the oscillation axis being at a center position between the two chain joints in the second direction.

The present configuration restricts the movement of the roller support, which is joined to the article holder, in the first direction and the second direction relative to the guide rail. This also restricts the movement of the roller chain, which is joined to the article holder, in the first direction and the second direction relative to the guide rail. Thus, the loads acting on the roller chain are easily reduced. Further, the roller support is joined to the article holder so as to be able to oscillate about the oscillation axis extending along the first direction. The oscillation axis is located at the center position between the two chain joints in the second direction. This facilitates properly performing the operation of causing the article holder to oscillate about the oscillation axis by operating the two lift mechanisms.

Further features and advantages of the technology according to the present disclosure will be further clarified by the following description of a non-limiting illustrative embodiment with reference to the drawings.

### BRIEF DESCRIPTION OF THE DRAWINGS

FIG. 1 is a side view of an article transport vehicle.

FIG. 2 is a front view of the article transport vehicle shown in FIG. 1.

FIG. 3 is a front view of an article holder shown in FIG. 1 that is oscillating.

FIG. 4 is a top view of the article transport vehicle shown in FIG. 1.

FIG. 5 is a top view of a first guide mechanism shown in FIG. 1.

FIG. 6 is a side view of the first guide mechanism shown in FIG. 1.

FIG. 7 is a side view showing another example of the first guide mechanism shown in FIG. 1.

FIG. 8 is a top view showing another example of the first guide mechanism shown in FIG. 1.

FIG. 9 is a top view showing another example of the first guide mechanism shown in FIG. 1.

### DESCRIPTION OF THE INVENTION

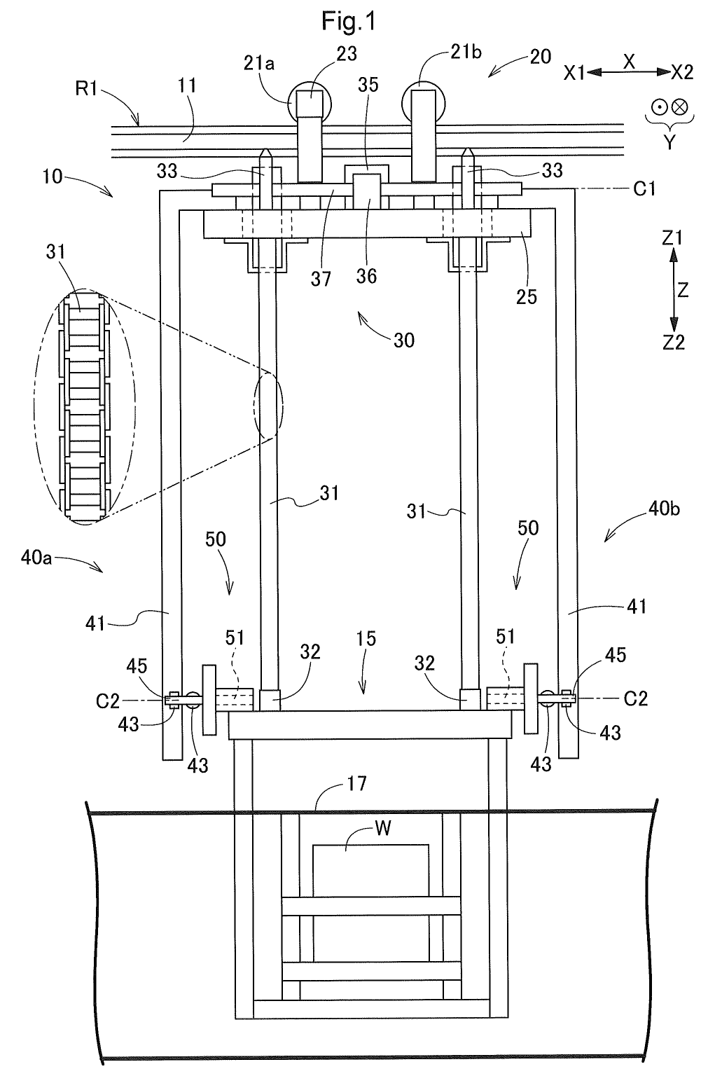

The following describes an embodiment of an article transport vehicle 10 for transporting an article W, with reference to the drawings. FIG. 1 shows an example of a side of the article transport vehicle 10.

The article transport vehicle 10 includes an article holder 15 for holding the article W, and a travel unit 20 that travels along a travel path R1. The article transport vehicle 10 travels along the travel path R1 to transport the article W. Examples of the article transport vehicle 10 include an unmanned transport vehicle, a transport vehicle that transports personnel and the article W, an autonomous transport vehicle, and a non-autonomous transport vehicle. The article transport vehicle 10 in the present embodiment is an unmanned overhead hoist transport vehicle. The travel path R1 in the present embodiment is formed of travel rails 11. The travel rails 11 are held in a suspended manner from a ceiling.

In the present embodiment, an article oscillation area 17 is located along the travel path R1. The article transport vehicle 10 moves to the article oscillation area 17 while holding the article W. The article transport vehicle 10 causes the article holder 15 holding the article W to oscillate in the article oscillation area 17. Examples of the article oscillation area 17 include surface treatment equipment for performing surface treatment on the article W, washing equipment for washing the article W, and drying equipment for drying the article W. The article oscillation area 17 in the present embodiment is a liquid tank containing a liquid.

Although the article W is not specifically limited, the article W in the present embodiment is a processing object subjected to surface treatment by the surface treatment equipment. Examples of the article W include a vehicle door, a vehicle component such as a vehicle body, machine exterior, and facility fixtures.

A first direction X and a second direction Y are two directions orthogonal to each other as viewed in the up-down direction. A first side X1 in the first direction X refers to one side in the first direction X, and a second side X2 in the first direction X refers to the other side. The first direction X and the second direction Y are directions along a horizontal plane. The first direction X and the second direction Y in the present embodiment are horizontal directions.

The article transport vehicle 10 includes the travel unit 20, which travels along the travel path R1. The travel unit 20 includes wheels that roll on travel surfaces (in the illustrated example, surfaces facing an upper side Z1) of the travel rails 11. The wheels in the present embodiment include a first wheel 21a and a second wheel 21b.

The travel unit 20 includes a travel drive source 23 for rotating the wheels. The travel unit 20 travels along the travel rails 11 as a result of the travel drive source 23 driving the wheels to rotate. The first wheel 21a in the present embodiment is a drive wheel that is driven to rotate by the travel drive source 23. The second wheel 21b in the present embodiment is an idler wheel.

The travel unit 20 includes a base 25. The base 25 is disposed on a lower side Z2 of the travel rail 11. The base 25 in the present embodiment is formed in a frame shape, e.g., a ladder-frame shape. Note that the base 25 may have a flat plate shape, a box shape, or the like, instead of a frame shape.

The article transport vehicle 10 includes a lift mechanism 30 for raising and lowering the article holder 15 relative to the travel unit 20. The lift mechanism 30 suspends and holds the article holder 15 relative to the travel unit 20. The article transport vehicle 10 in the present embodiment includes a pair of lift mechanisms 30 that suspends and holds the article holder 15 and raises and lowers the article holder 15.

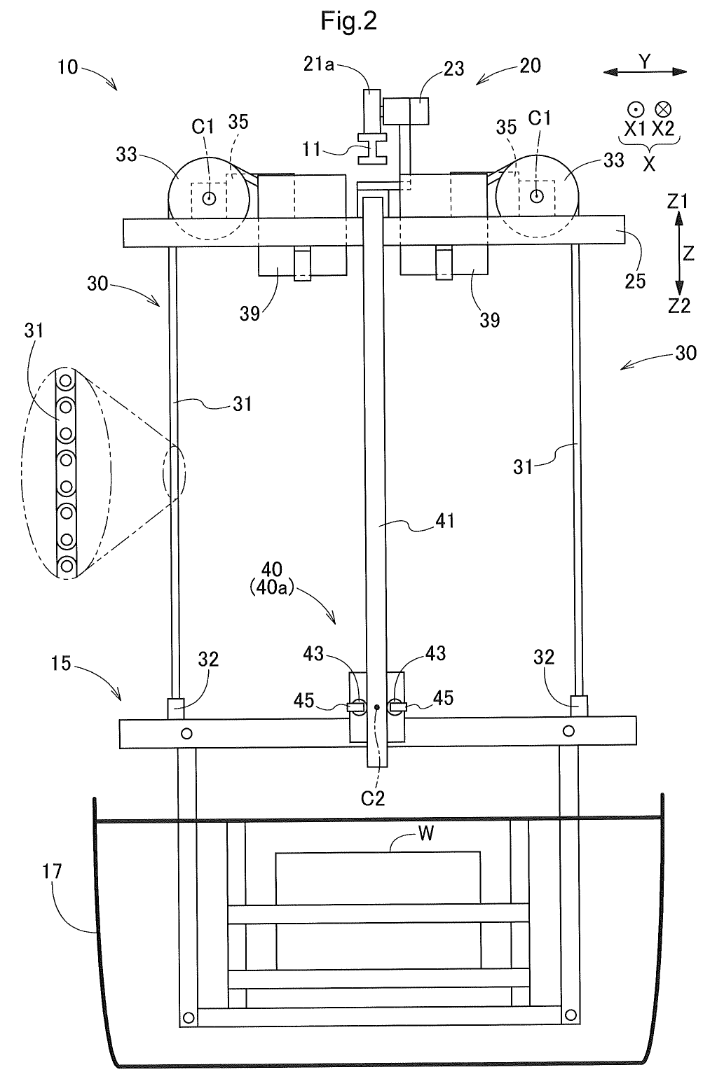

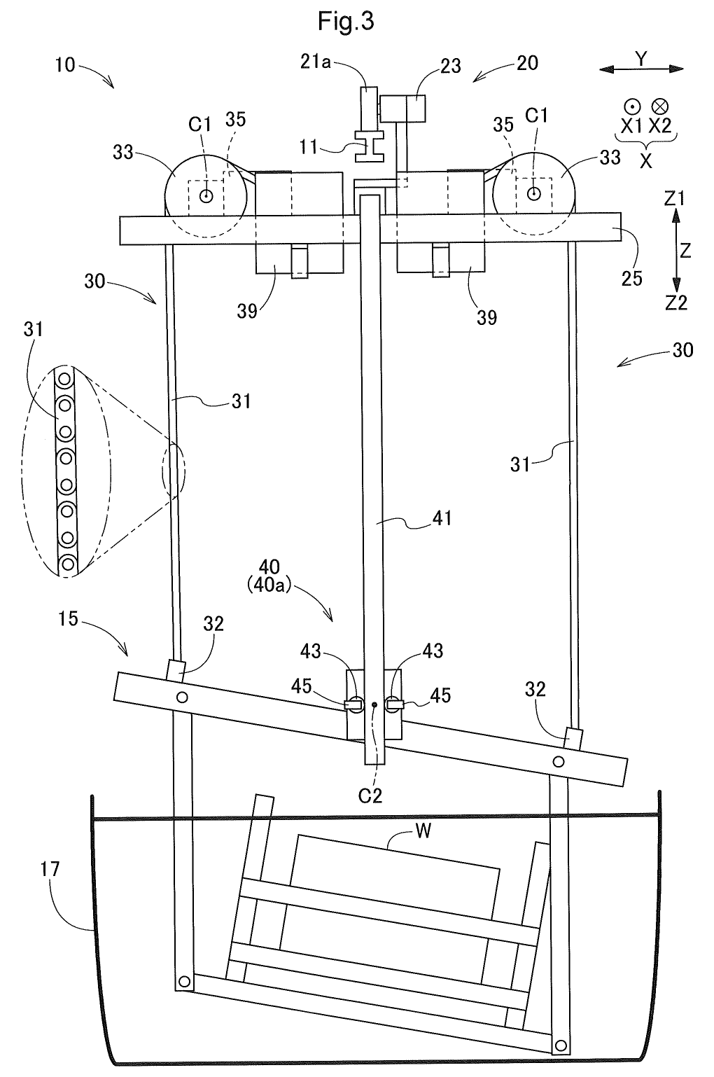

FIG. 2 shows an example of the front of the article transport vehicle 10. FIG. 3 shows an example of the article holder 15 that is oscillating. Each of the two lift mechanisms 30 includes a roller chain 31. Each of the two lift mechanisms 30 includes a chain joint 32 that joins the roller chain 31 and the article holder 15.

The roller chain 31 suspend and holds the article holder 15 relative to the base 25. In the present embodiment, one end of the roller chain 31 is fixed to the base 25. In the present embodiment, the other end of the roller chain 31 is fixed to the article holder 15 at the chain joint 32. Note that the chain joint 32 may be a sprocket fixed to the article holder 15, and both ends of the roller chain 31 may be fixed to the base 25.

As shown in FIG. 2, two chain joints 32 are separated in the second direction Y as viewed along the first direction X. In the present embodiment, the chain joint 32 included in one of the two lift mechanisms 30 and the chain joint 32 included in the other one of the two lift mechanisms 30 are separated in the second direction Y as viewed along the first direction X.

In the present embodiment, each of the two lift mechanisms 30 includes a plurality of (two in the illustrated example) chain joints 32. In the present embodiment, each of the two lift mechanisms 30 includes a plurality of chain joints 32 separated in the first direction X as viewed along the second direction Y.

In the present embodiment, the plurality of chain joints 32 included in one of the two lift mechanisms 30 and the plurality of chain joints 32 included in the other one of the two lift mechanisms 30 are separated in the second direction Y as viewed along the first direction X. In other words, the pair of lift mechanisms 30 includes a plurality of pairs (two pairs in the illustrated example) of chain joints 32, and the plurality of pairs of chain joints 32 are separated in the second direction Y as viewed along the first direction X.

Each of the two lift mechanisms 30 includes a drive sprocket 33 for winding and unwinding the roller chain 31. The drive sprocket 33 in the present embodiment is rotatably attached to the base 25 about a rotational axis C1.

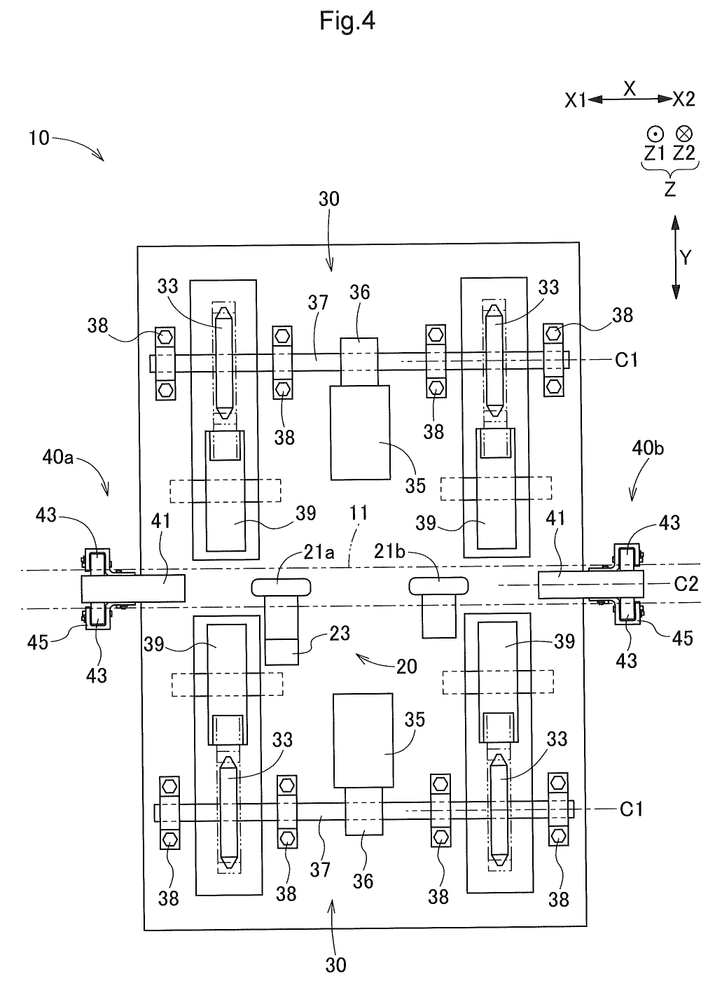

FIG. 4 shows an example of the top of the article transport vehicle 10. The rotational axis C1 of the drive sprocket 33 is aligned with a direction intersecting the up-down direction Z. Note that the rotational axis C1 of the drive sprocket 33 may be aligned with a direction along a horizontal plane and intersecting both the first direction X and the second direction Y. In the present embodiment, the rotational axis C1 of the drive sprocket 33 is aligned with the first direction X.

The lift mechanism 30 includes a drive source 35 for rotating the drive sprocket 33. In the present embodiment, each of the two lift mechanisms 30 includes the drive source 35. The drive source 35 in the present embodiment is fixed to the base 25.

Each lift mechanism 30 includes a speed reducer 36. In the present embodiment, the rotation output from the drive source 35 is subjected to speed reduction by the speed reducer 36 and transmitted to the drive sprocket 33. The drive sprocket 33 is supported by a shaft member 37.

The shaft member 37 in the present embodiment is supported by shaft support members 38 so as to be rotatable about the rotational axis C1 together with the drive sprocket 33. The shaft support members 38 are supported by the travel unit 20. As shown in FIG. 4, the shaft support members 38 are fixed to the base 25. Note that the shaft support members 38 are omitted in FIGS. 1 to 3.

Each of the two lift mechanisms 30 includes a roller chain housing 39. The roller chain 31 wound by the drive sprocket 33 is housed in the roller chain housing 39. The roller chain housing 39 is fixed to the base 25.

In the present embodiment, each of the two lift mechanisms 30 includes a plurality of (two in the illustrated example) roller chains 31 and a plurality of (two in the illustrated example) drive sprockets 33. Thus, the pair of lift mechanisms 30 in the present embodiment includes a plurality of pairs (two pairs in the illustrated example) of roller chains 31 and a plurality of pairs (two pairs in the illustrated example) of drive sprockets 33.

The pair of lift mechanisms 30 raises and lowers the article holder 15 by winding and unwinding the plurality of roller chains 31 while the article holder 15 is suspended by the plurality of roller chains 31. In the present embodiment, the pair of lift mechanisms 30 raises the article holder 15 by winding the plurality of (four in the illustrated example) roller chains 31. In the present embodiment, the pair of lift mechanisms 30 lowers the article holder 15 by unwinding the plurality of (four in the illustrated example) roller chains 31.

As shown in FIG. 3, the pair of lift mechanisms 30 causes the article holder 15 to oscillate about an oscillation axis C2, which extends along the first direction X, by winding and unwinding the roller chains 31 while the article holder 15 is suspended by the plurality of roller chains 31. In the present embodiment, one of the two lift mechanisms 30 winds the plurality of (two in the illustrated example) roller chains 31, and the other one of the two lift mechanisms 30 unwinds the plurality of (two in the illustrated example) roller chains 31, thereby causing the article holder 15 to oscillate about the oscillation axis C2.

As shown in FIG. 2, the article transport vehicle 10 includes a guide mechanism 40 for guiding the article holder 15 in a lifting direction. In the present embodiment, the guide mechanism 40 guides the article holder 15 in the up-down direction Z. Note that the lifting direction may contain a horizontal component in addition to a component in the up-down direction Z. In the present embodiment, the article transport vehicle 10 includes a plurality of guide mechanisms 40. As shown in FIG. 1, the plurality of guide mechanisms 40 include a first guide mechanism 40a and a second guide mechanism 40b located on the second side X2 in the first direction X relative to the first guide mechanism 40a.

The guide mechanism 40 includes a guide rail 41. The guide rail 41 extends along the up-down direction Z. The guide rail 41 in the present embodiment extends in a direction parallel to the up-down direction Z. The guide rail 41 is held by the travel unit 20. The guide rail 41 in the present embodiment is attached to the base 25. Examples of the shape of the guide rail 41 include a polygonal-tubular shape, a circular-tubular shape, a polygonal-columnar shape, a circular-columnar shape, an H-shape, an L-shape, and a U-shape. The guide rail 41 in the present embodiment has a rectangular tubular shape.

Regarding the shape of a component, the term “extending” in a certain direction as a reference direction is used as a concept that includes not only a shape in which the extension direction of the component is parallel to the reference direction, but also a shape in which the extension direction of the component intersects the reference direction but the intersection angle is within a predetermined range (e.g., less than 20°).

The guide rail 41 is made of, for example, a material having high wear resistance. The guide rail 41 is subjected to, for example, surface treatment to impart high wear resistance. The guide rail 41 in the present embodiment is subjected to hot-dip galvanizing treatment.

In the present embodiment, each of the first guide mechanism 40a and the second guide mechanism 40b includes the guide rail 41, as shown in FIG. 1. In the present embodiment, the guide rail 41 of the first guide mechanism 40a is located on the first side X1 in the first direction X relative to the guide rail 41 of the second guide mechanism 40b. The guide rail 41 of the first guide mechanism 40a and the guide rail 41 of the second guide mechanism 40b are fixed to the base 25. In the present embodiment, the guide rail 41 of the first guide mechanism 40a and the guide rail 41 of the second guide mechanism 40b are unmovable in the first direction X relative to each other. In the present embodiment, the guide rail 41 of the first guide mechanism 40a and the guide rail 41 of the second guide mechanism 40b are unmovable in the second direction Y relative to each other.

The guide mechanism 40 includes a roller 43 that rolls in contact with the guide rail 41. Examples of the shape of the roller 43 include a circular-tubular shape, a circular-tubular shape with a recessed center, a circular-tubular shape with a bulging center, and a circular-columnar shape. The roller 43 in the present embodiment has a circular-tubular shape. The material of the roller 43 is, for example, a material having high wear resistance. In the present embodiment, the material of the roller 43 is ultra-high molecular weight polyethylene.

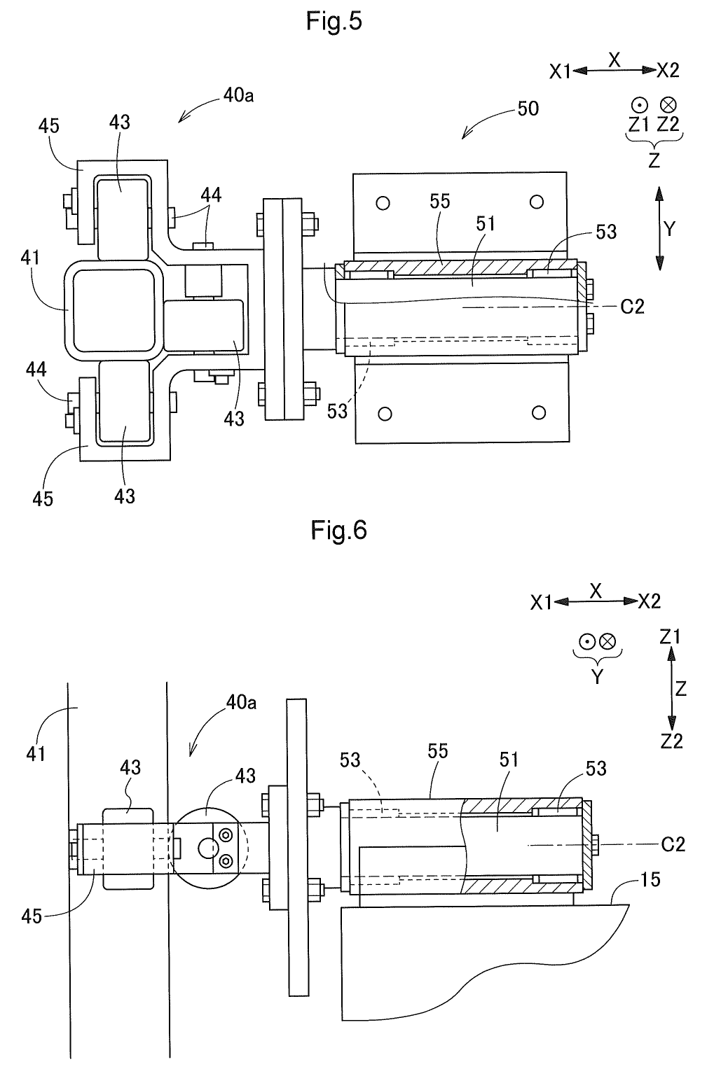

FIG. 5 shows an example of the top of the guide mechanism 40 and a joint mechanism 50. In FIG. 5, the first guide mechanism 40a is shown as a representative of the plurality of guide mechanisms 40. The guide mechanism 40 includes a roller support shaft 44 for supporting the roller 43. In the present embodiment, the roller 43 is supported such that the inner surface of the roller 43 slides with the outer surface of the roller support shaft 44. In the present embodiment, the material of the roller support shaft 44 is metal.

In the present embodiment, a portion of the guide rail 41 of the first guide mechanism 40a with which the roller 43 comes into contact is disposed not to overlap the article holder 15 as viewed in the up-down direction, as shown in FIG. 4. In the present embodiment, a portion of the guide rail 41 of the second guide mechanism 40b with which the roller 43 comes into contact is disposed not to overlap the article holder 15 as viewed in the up-down direction.

As shown in FIG. 5, the guide mechanism 40 includes a plurality of rollers 43 that roll in contact with the guide rail 41. In the present embodiment, each of the first guide mechanism 40a and the second guide mechanism 40b includes a plurality of rollers 43. In the present embodiment, each of the first guide mechanism 40a and the second guide mechanism 40b includes three rollers 43.

Each guide mechanism 40 includes a roller support 45 for supporting the plurality of rollers 43. In the present embodiment, each of the first guide mechanism 40a and the second guide mechanism 40b includes the roller support 45. In the illustrated example, each of the first guide mechanism 40a and the second guide mechanism 40b includes the roller support 45 for supporting the three rollers 43.

The plurality of rollers 43 make the roller support 45 movable in the up-down direction Z relative to the guide rail 41. In the present embodiment, rolling axes of the rollers 43 are orthogonal to the extension direction of the guide rail 41. In the present embodiment, the rolling axis of each of the rollers 43 extends along the first direction X or the second direction Y. In the illustrated example, the rolling axis of each of the rollers 43 extends along a direction parallel to the first direction X or a direction parallel to the second direction Y.

The plurality of rollers 43 are disposed in such a manner as to restrict the movement of the roller support 45 in the first direction X relative to the guide rail 41. In the first guide mechanism 40a in the present embodiment, at least one of the plurality of rollers 43 is disposed in such a manner as to restrict the movement of the roller support 45 toward one side in the first direction X relative to the guide rail 41. In the second guide mechanism 40b in the present embodiment, at least one of the plurality of rollers 43 is disposed in such a manner as to restrict the movement of the roller support 45 toward the other side in the first direction X relative to the guide rail 41.

The plurality of rollers 43 are disposed in such a manner as to restrict the movement of the roller support 45 in the second direction Y relative to the guide rail 41. In the first guide mechanism 40a in the present embodiment, at least one of the plurality of rollers 43 is disposed in such a manner as to restrict the movement of the roller support 45 toward one side in the second direction Y relative to the guide rail 41. In the second guide mechanism 40b in the present embodiment, at least one of the plurality of rollers 43 is disposed in such a manner as to restrict the movement of the roller support 45 toward the other side in the second direction Y relative to the guide rail 41.

In the first guide mechanism 40a in the present embodiment, the plurality of rollers 43 are disposed in such a manner as to restrict the movement of the roller support 45 toward the first side X1 in the first direction X and both sides in the second direction Y relative to the guide rail 41. In the second guide mechanism 40b in the illustrated example, the plurality of rollers 43 are disposed in such a manner as to restrict the movement of the roller support 45 toward the second side X2 in the first direction X and both sides in the second direction Y relative to the guide rail 41.

In the present embodiment, the roller 43 restricting the movement of the roller support 45 in the first direction X relative to the guide rail 41 and the roller 43 restricting the movement of the roller support 45 in the second direction Y relative to the guide rail 41 are disposed such that the positions of these rollers 43 in the up-down direction Z overlap. In the present embodiment, the roller support 45 supports the plurality of rollers 43 such that the positions, in the up-down direction Z, of the roller 43 restricting the movement of the roller support 45 toward one side in the second direction Y relative to the guide rail 41 and the roller 43 restricting the movement of the roller support 45 toward the other side in the second direction Y relative to the guide rail 41 overlap.

In the present embodiment, the roller 43 restricting the movement of the roller support 45 toward one side in the first direction X relative to the guide rail 41 in the first guide mechanism 40a and the roller 43 restricting the movement of the roller support 45 toward the other side in the first direction X relative to the guide rail 41 in the second guide mechanism 40b are disposed such that the positions of these rollers 43 in the up-down direction Z overlap.

The roller support 45 in the present embodiment supports the plurality of rollers 43 such that the positions of the plurality of rollers 43 in the up-down direction Z overlap each other. Note that the roller support 45 may also support a plurality of rollers 43 restricting the movement in the first direction X so as to be separated in the up-down direction Z. Further, the roller support 45 may also support a plurality of rollers 43 restricting the movement in the second direction Y so as to be separated in the up-down direction Z.

As shown in FIG. 5, the guide mechanism 40 includes the joint mechanism 50 for joining the roller support 45 to the article holder 15. In the present embodiment, each of the first guide mechanism 40a and the second guide mechanism 40b includes the joint mechanism 50.

FIG. 6 shows an example of a side of the joint mechanism 50. As shown in FIGS. 5 and 6, the joint mechanism 50 joins the roller support 45 to the article holder 15 such that the roller support 45 can oscillate about the oscillation axis C2, which extends along the first direction X. In the present embodiment, the oscillation axis C2 is an axis parallel to the first direction X.

As shown in FIGS. 2 and 3, the oscillation axis C2 is located at an intermediate point in the second direction Y between two chain joints 32 separated in the second direction Y. The oscillation axis C2 in the present embodiment is located at a center position between the two chain joints 32 in the second direction Y. The center position includes positions within a certain area on both sides of a position equidistant between the two chain joints 32. The certain area is, for example, an area of one fifth, one tenth, or one twentieth of the distance between the two chain joints 32. In the present embodiment, the oscillation axis C2 is located at a position overlapping the guide rail 41 as viewed along the first direction X.

The oscillation axis C2 in the present embodiment is located at a center position in the second direction Y between the chain joint 32 included in one of the two lift mechanisms 30 and the chain joint 32 included in the other one of the two lift mechanisms 30. The oscillation axis C2 in the present embodiment is located at a center position between the two chain joints 32 as viewed along the first direction X.

As shown in FIGS. 5 and 6, the joint mechanism 50 includes an oscillation shaft member 51 fixed to the roller support 45. The oscillation shaft member 51 is located on the oscillation axis C2. In the present embodiment, each of the two rollers 43 that come into contact with the guide rail 41 from the corresponding side in the second direction Y is located at a position overlapping the position of the oscillation axis C2 in the up-down direction Z. In the present embodiment, the roller 43 that comes into contact with the guide rail 41 from the first side X1 or second side X2 in the first direction X is located at a position overlapping the position of the oscillation axis C2 in the up-down direction Z.

The joint mechanism 50 includes a bearing 53 that rotatably supports the oscillation shaft member 51 relative to the article holder 15. Examples of the bearing 53 include a sliding bearing, a roller bearing, and a ball bearing. In the present embodiment, the bearing 53 is a sliding bearing.

The bearing 53 is housed in a bearing case 55. The bearing case 55 is supported by the article holder 15. In the present embodiment, the inner surface of the bearing 53 is supported by the oscillation shaft member 51, and the outer surface of the bearing 53 is supported by the bearing case 55. The bearing case 55 is fixed to the article holder 15.

The joint mechanism 50 in the present embodiment includes a plurality of (two in the illustrated example) bearings 53 that rotatably support the oscillation shaft member 51 relative to the article holder 15. The bearings 53 are spaced apart in the first direction X.

Returning to FIGS. 2 and 3, the article oscillation area 17 in the present embodiment is a liquid tank used to immerse the article W for surface treatment. The first direction X in the present embodiment is the transport direction. In other words, the first direction X is the longitudinal direction of the travel rails 11. In the present embodiment, the rotational axis C1 of the drive sprocket 33 extends parallel to the first direction X.

In the present embodiment, the pair of lift mechanisms 30 raises and lowers the article holder 15 between a travel position, which is a position on the upper side Z1 relative to the article oscillation area 17, and a processing position at a height lower than or equal to the article oscillation area 17. The travel unit 20 in the present embodiment can travel in the first direction X with the article holder 15 in the travel position. In the present embodiment, the pair of lift mechanisms 30 can cause the article holder 15 to oscillate about the oscillation axis C2 with the article holder 15 in the processing position.

The travel unit 20 in the present embodiment can travel in the first direction X while the article W is immersed in the article oscillation area 17. After the immersion of the article W ends, the pair of lift mechanisms 30 brings the article holder 15 into the travel position.

The article oscillation area 17 in the present embodiment is an electrodeposition treatment tank used to immerse the article W. The article W is immersed in the article oscillation area 17 before coating treatment.

As described above, the article transport vehicle 10 of the present embodiment is configured such that the rotational axis C1 of the drive sprocket 33 extends parallel to the first direction X, which is the transport direction. In this arrangement, a load in a direction different from the winding direction, particularly in the direction of the rotational axis C1, is likely to be applied to the roller chain 31. While the travel unit 20 travels in the first direction X with the article W immersed, a large load in a direction different from the winding direction is likely to be applied to the roller chain 31.

In the present embodiment, the plurality of rollers 43 in the pair of guide mechanisms 40 are disposed in such a manner as to restrict the movement of the roller support 45 toward both sides in the first direction X and both sides in the second direction Y relative to the guide rail 41. Thus, the movement of the roller chain 31, which is joined to the article holder 15, toward both sides in the first direction X relative to the guide rail 41 is restricted.

The above-described article transport vehicle 10 facilitates reducing loads in directions different from the winding direction acting on the roller chain 31. The above-described article transport vehicle 10 facilitates restricting the movement of the oscillation axis C2 of the article holder 15 in the second direction Y. Thus, the distances between the article holder 15 and the surrounding structures can be reduced. The plurality of guide mechanisms 40 in the above-described article transport vehicle 10 are disposed so as not to interfere with the article holder 15. Thus, the dimension in the up-down direction Z of the article transport vehicle 10 is easily reduced.

Next, other embodiments of the article transport vehicle 10 will be described.

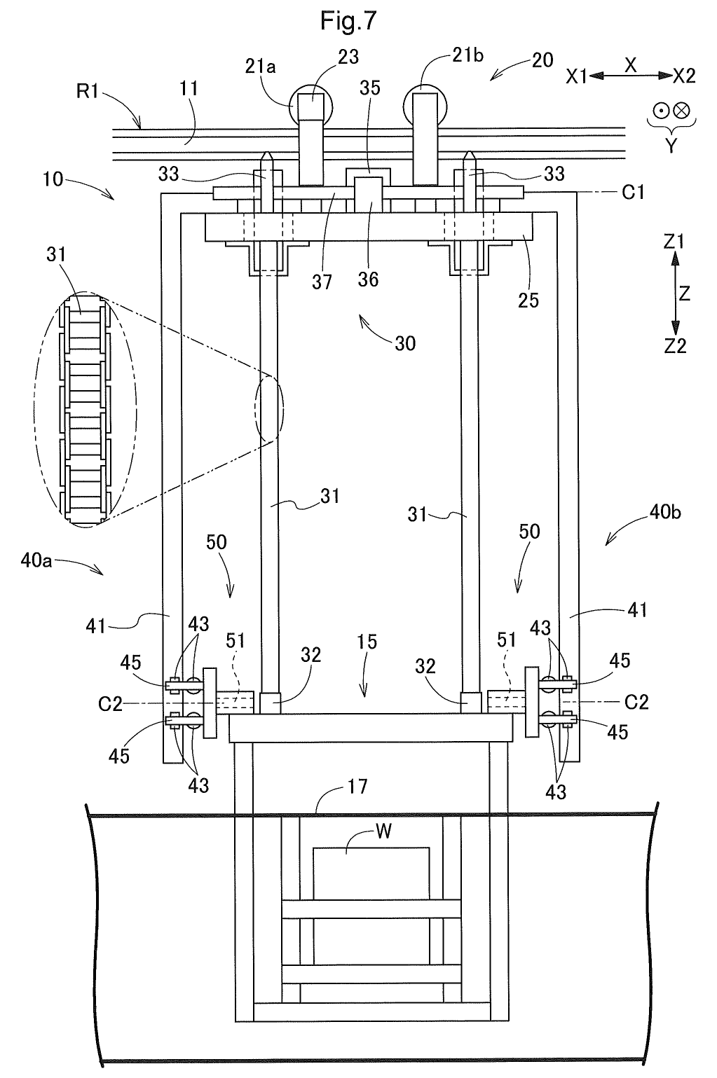

(1) The above embodiment describes an example configuration in which the positions of all the rollers 43 in the up-down direction Z overlap the position of the oscillation axis C2 in the up-down direction Z. However, the embodiment of the article transport vehicle 10 is not limited to this configuration. For example, the positions of all the rollers 43 in the up-down direction Z need not necessarily coincide with the position of the oscillation axis C2 in the up-down direction Z, as in an example shown in FIG. 7. In the embodiment shown in FIG. 7, the roller support 45 supports a plurality of (three in the illustrated example) rollers 43 at a plurality of (two in the illustrated example) levels such that the rollers 43 are aligned in directions along the up-down direction Z.

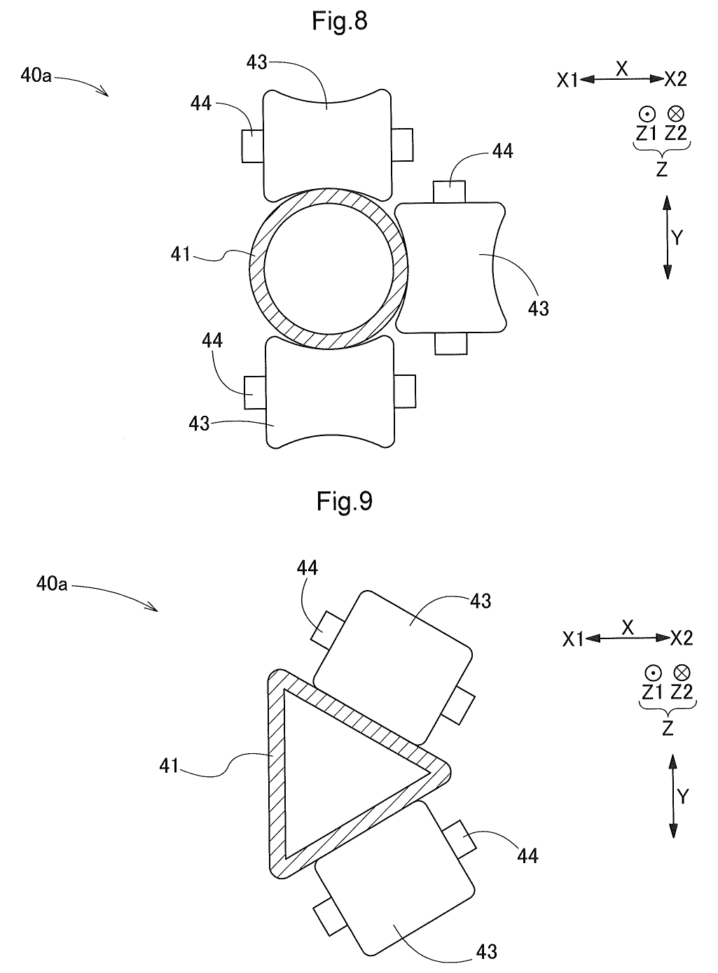

(2) The above embodiment describes an example configuration in which the guide rail 41 has a rectangular-tubular shape, and the roller 43 has a circular-tubular shape. However, the embodiment of the article transport vehicle 10 is not limited to this configuration. For example, the guide rail 41 may have a circular-tubular shape, as shown in FIG. 8. For example, the guide rail 41 may have a triangular-tubular shape, as shown in FIG. 9. Note that FIGS. 8 and 9 are top views of the guide mechanism 40, and show only the guide rail 41, the rollers 43, and the roller support shaft 44 schematically. Both FIGS. 8 and 9 illustrate the first guide mechanism 40a as a representative of the plurality of guide mechanisms 40. With the structures shown in FIGS. 8 and 9 as well, the plurality of rollers 43 can restrict the movement of the roller support 45 in the first direction X and in the second direction Y relative to the guide rail 41.

(3) The above embodiment describes an example configuration in which the rotational axis C1 of the drive sprocket 33 extends along the first direction X, and the transport direction is the first direction X. However, the embodiment of the article transport vehicle 10 is not limited to this configuration. For example, the rotational axis C1 may extend along the first direction X, and the transport direction may be the second direction Y, i.e., the second direction Y may be the longitudinal direction of the travel rails 11. For example, the rotational axis C1 may extend along the second direction Y, and the transport direction may be the first direction X, i.e., the first direction X may be the longitudinal direction of the travel rails 11.

(4) The above embodiment describes an example configuration in which each of the two lift mechanisms 30 has two roller chains 31, two chain joints 32, and two drive sprockets 33. However, the embodiment of the article transport vehicle 10 is not limited to this configuration. For example, a configuration may be employed in which each of the two lift mechanisms 30 includes one roller chain 31, one chain joint 32, and one drive sprocket 33, and the chain joint 32 included in one of the two lift mechanisms 30 and the chain joint 32 included in the other one of the two lift mechanisms 30 are separated in the second direction Y as viewed along the first direction X.

(5) The above embodiment describes an example configuration in which the rotational axis C1 of the drive sprocket 33 extends parallel to the first direction X, and the article transport vehicle 10 includes two guide mechanisms 40. However, the embodiment of the article transport vehicle 10 is not limited to this configuration. For example, the rotational axis C1 of the drive sprocket 33 may be parallel to the second direction Y. For example, the article transport vehicle 10 may include only one guide mechanism 40. For example, the article transport vehicle 10 may include three or more guide mechanisms 40.

(6) The above embodiment describes an example configuration in which the joint mechanism 50 includes the oscillation shaft member 51 fixed to the roller support 45, and two bearings 53 rotatably supporting the oscillation shaft member 51 from the outer side. However, the embodiment of the article transport vehicle 10 is not limited to this configuration. For example, only one bearing 53 may rotatably support the oscillation shaft member 51 relative to the article holder 15. For example, a configuration may be employed in which the oscillation shaft member 51 has a tubular shape, and the bearing 53 rotatably supports the oscillation shaft member 51 from the inner side. For example, a plurality of bearings 53 may be disposed in contact with each other in the first direction X.

(7) The above embodiment describes an example configuration in which the inner surface of the bearing 53 is supported by the oscillation shaft member 51, the outer surface of the bearing 53 is supported by the bearing case 55, and the bearing case 55 is fixed to the article holder 15. However, the embodiment of the article transport vehicle 10 is not limited to this configuration. For example, the inner surface of the bearing 53 may be supported by the bearing case 55, and the outer surface of the bearing 53 may be supported by the oscillation shaft member 51. For example, the bearing 53 need not necessarily be housed in the bearing case 55. For example, the bearing 53 need not necessarily be a sliding bearing.

(8) The above embodiment describes an example configuration in which the drive sprocket 33, the drive source 35, the shaft support member 38, the roller chain housing 39, and the guide rail 41 are attached to the base 25. However, the embodiment of the article transport vehicle 10 is not limited to this configuration. For example, the drive sprocket 33, the drive source 35, the shaft support member 38, and the roller chain housing 39 may be attached to the article holder 15. For example, the guide rail 41 may be attached to a member different from the base 25 of the travel unit 20.

(9) The above embodiment describes an example configuration in which each of the two lift mechanisms 30 includes the drive source 35. However, the embodiment of the article transport vehicle 10 is not limited to this configuration. For example, the pair of lift mechanisms 30 may include a planetary gear mechanism that distributes driving force and share one drive source 35. For example, the pair of lift mechanisms 30 need not necessarily include the speed reducer 36.

(10) The above embodiment describes an example configuration in which the oscillation axis C2 is located at the center position between the two chain joints 32 as viewed along the first direction X. However, the embodiment of the article transport vehicle 10 is not limited to this configuration. For example, the oscillation axis C2 may be separated in the up-down direction Z from the center position between the two chain joints 32 as viewed along the first direction X. For example, the oscillation axis C2 may be located at a position separated in the second direction Y from the center position between the two chain joints 32 in the second direction Y.

(11) The above embodiment describes an example configuration in which the rolling axis of each roller 43 extends parallel to the first direction X or the second direction Y, and the rotational axis C1 and the oscillation axis C2 are parallel to the first direction X. However, the embodiment of the article transport vehicle 10 is not limited to this configuration. For example, the rotational axis C1 may be parallel to a direction along the first direction X and intersecting the first direction X at a predetermined angle (e.g., 10 degrees) or less. For example, the oscillation axis C2 may be parallel to a direction along the first direction X and intersecting the first direction X at a predetermined angle (e.g., 10 degrees) or less. For example, the rolling axis of each roller 43 may be parallel to a direction along the first direction X or the second direction Y and intersecting that direction at a predetermined angle (e.g., 40 degrees) or less.

(12) The above embodiment describes an example configuration in which each of the first guide mechanism 40a and the second guide mechanism 40b includes three rollers 43. However, the embodiment of the article transport vehicle 10 is not limited to this configuration. For example, each of the first guide mechanism 40a and the second guide mechanism 40b may include only one roller 43. For example, each of the first guide mechanism 40a and the second guide mechanism 40b may include only two rollers 43.

(13) The above embodiment describes an example configuration in which the plurality of rollers 43 included in the guide mechanism 40 are disposed in such a manner as to restrict the movement of the roller support 45 in the first direction X and the second direction Y relative to the guide rail 41. However, the embodiment of the article transport vehicle 10 is not limited to this configuration. For example, all the rollers 43 in the first guide mechanism 40a may be disposed in such a manner as to restrict the movement of the roller support 45 toward one side in the first direction X relative to the guide rail 41, and all the rollers 43 in the second guide mechanism 40b may be disposed in such a manner as to restrict the movement of the roller support 45 toward the other side in the first direction X relative to the guide rail 41. For example, all the rollers 43 in the first guide mechanism 40a may be disposed in such a manner as to restrict the movement of the roller support 45 toward one side in the second direction Y relative to the guide rail 41, and all the rollers 43 in the second guide mechanism 40b may be disposed in such a manner as to restrict the movement of the roller support 45 toward the other side in the second direction Y relative to the guide rail 41.

(14) Note that the configurations disclosed in the above embodiment can also be applied in combination with the configurations disclosed in the other embodiments as long as no contradiction arises. As with the other configurations as well, the embodiments disclosed in the present specification are in all respects merely examples. Accordingly, it is possible to make various changes as appropriate without departing from the gist of the present disclosure.

The article transport vehicle according to the present disclosure will be described below.

As an aspect, an article transport vehicle configured to transport an article, includes: a travel unit configured to travel along a travel path; an article holder configured to hold the article; two lift mechanisms suspending and holding the article holder and configured to raise and lower the article holder; and at least one guide mechanism configured to guide the article holder in a lifting direction, each of the two lift mechanisms including: a roller chain; a drive sprocket configured to wind and unwind the roller chain; and a chain joint joining the roller chain and the article holder to each other, the chain joints of the two lift mechanisms being separated from each other in a second direction as viewed along a first direction, the first direction and the second direction being orthogonal to each other as viewed vertically, the drive sprocket having a rotational axis extending along a direction intersecting an up-down direction, the guide mechanism including: a guide rail held by the travel unit and extending along the up-down direction; a plurality of rollers configured to roll in contact with the guide rail; a roller support supporting the plurality of rollers; and a joint mechanism joining the roller support to the article holder, the plurality of rollers being disposed in such a manner as to restrict movement of the roller support in the first direction and movement in the second direction, while allowing the roller support to move in the up-down direction relative to the guide rail, the joint mechanism joining the roller support to the article holder in such a manner as to allow the roller support to oscillate about an oscillation axis extending along the first direction, the oscillation axis being at a center position between the two chain joints in the second direction.

The present configuration restricts the movement of the roller support, which is joined to the article holder, in the first direction and the second direction relative to the guide rail. This also restricts the movement of the roller chain, which is joined to the article holder, in the first direction and the second direction relative to the guide rail. Thus, the loads acting on the roller chain are easily reduced. Further, the roller support is joined to the article holder so as to be able to oscillate about the oscillation axis extending along the first direction. This oscillation axis is located at the center position between the two chain joints in the second direction. This facilitates properly performing the operation of causing the article holder to oscillate about the oscillation axis by operating the two lift mechanisms.

As an aspect, the rotational axis of the drive sprocket extends along the first direction, the at least one guide mechanism includes a plurality of guide mechanisms, the plurality of guide mechanisms include: a first guide mechanism; and a second guide mechanism located on a second side in the first direction relative to the first guide mechanism, the second side in the first direction being one of two sides in the first direction, the plurality of rollers in the first guide mechanism are disposed in such a manner as to restrict movement of the roller support toward a first side in the first direction and both sides in the second direction relative to the guide rail, the first side in the first direction being the other one of the two sides in the first direction, and the plurality of rollers in the second guide mechanism are disposed in such a manner as to restrict movement of the roller support toward the second side in the first direction and both sides in the second direction relative to the guide rail.

According to the present configuration, the article transport vehicle includes a plurality of guide mechanisms. This makes it easier to stably guide the article holder than in the case of one guide mechanism. In the first guide mechanism on the first side in the first direction, the plurality of rollers need not be disposed on the first side in the first direction relative to the guide rail. In the second guide mechanism on the second side in the first direction, the plurality of rollers need not be disposed on the second side in the first direction relative to the guide rail. This facilitates reducing the dimensions of the portions of the first guide mechanism and the second guide mechanism that project outward relative to the article holder in the first direction. Further, the structure of the roller support supporting the plurality of rollers is easily simplified. Further, the rotational axis of the drive sprocket extends along the first direction. This facilitates reducing the loads applied to the roller chain while the article holder oscillates about the oscillation axis extending along the first direction compared to, for example, the rotational axis of the drive sprocket extending along the second direction.

As an aspect, the joint mechanism includes: an oscillation shaft member located on the oscillation axis and fixed to the roller support; and a plurality of bearings rotatably supporting the oscillation shaft member relative to the article holder, and the plurality of bearings are spaced apart from each other in the first direction.

According to the present configuration, the oscillation shaft member is easily supported appropriately even when one of the plurality of rollers becomes difficult to move up and down relative to the guide rail, and a moment acts on the oscillation shaft member about an axis intersecting the oscillation axis.

As an aspect, the joint mechanism includes: an oscillation shaft member located on the oscillation axis and fixed to the roller support; and a sliding bearing rotatably supporting the oscillation shaft member relative to the article holder, and the sliding bearing is in a bearing case supported by the article holder.

According to this configuration, the sliding bearing is housed in the bearing case, thereby making it difficult for dust to enter. Further, using the sliding bearing facilitates increasing the diameter of the oscillation shaft member without increasing the outer diameter of the bearing, compared to a configuration using a rolling bearing. Thus, the strength of the oscillation shaft member is easily increased.

The article transport vehicle according to the present disclosure need only exhibit at least one of the above-described effects. The technical features of the article transport vehicle according to the present disclosure are also applicable to an article transport method and an article transport program.

### Description of Reference Signs

10: Article transport vehicle

15: Article holder

20: Travel unit

30: Lift mechanism

31: Roller chain

32: Chain joint

33: Drive sprocket

37: Shaft member

40: Guide mechanism

40a: First guide mechanism

40b: Second guide mechanism

41: Guide rail

43: Roller

45: Roller support

50: Joint mechanism

51: Oscillation shaft member

53: Bearing

55: Bearing case

C1: Rotational axis

C2: Oscillation axis

R1: Travel path

W: Article

X: First direction

X1: First side in first direction

X2: Second side in first direction

Y: Second direction

What is claimed is:

1. An article transport vehicle configured to transport an article, comprising:
a travel unit configured to travel along a travel path;
an article holder configured to hold the article;
two lift mechanisms suspending and holding the article holder and configured to raise and lower the article holder; and
at least one guide mechanism configured to guide the article holder in a lifting direction, and wherein:
each of the two lift mechanisms comprises:
a roller chain;
a drive sprocket configured to wind and unwind the roller chain; and
a chain joint joining the roller chain and the article holder to each other,
the chain joints of the two lift mechanisms are separated from each other in a second direction as viewed along a first direction, the first direction and the second direction being orthogonal to each other as viewed vertically,
the drive sprocket has a rotational axis extending along a direction intersecting an up-down direction,
the guide mechanism comprises:
a guide rail held by the travel unit and extending along the up-down direction;
a plurality of rollers configured to roll in contact with the guide rail;
a roller support supporting the plurality of rollers; and
a joint mechanism joining the roller support to the article holder,
the plurality of rollers are disposed in such a manner as to restrict movement of the roller support in the first direction and movement in the second direction, while allowing the roller support to move in the up-down direction relative to the guide rail,
the joint mechanism joins the roller support to the article holder in such a manner as to allow the roller support to oscillate about an oscillation axis extending along the first direction, and
the oscillation axis is at a center position between the two chain joints in the second direction.

2. The article transport vehicle according to claim 1, wherein:
the rotational axis of the drive sprocket extends along the first direction,
the at least one guide mechanism comprises a plurality of guide mechanisms,
the plurality of guide mechanisms comprise:
a first guide mechanism; and
a second guide mechanism located on a second side in the first direction relative to the first guide mechanism, the second side in the first direction being one of two sides in the first direction,
the plurality of rollers in the first guide mechanism are disposed in such a manner as to restrict movement of the roller support toward a first side in the first direction and both sides in the second direction relative to the guide rail, the first side in the first direction being the other one of the two sides in the first direction, and
the plurality of rollers in the second guide mechanism are disposed in such a manner as to restrict movement of the roller support toward the second side in the first direction and both sides in the second direction relative to the guide rail.

3. The article transport vehicle according to claim 1, wherein:
the joint mechanism comprises:
an oscillation shaft member located on the oscillation axis and fixed to the roller support; and
a plurality of bearings rotatably supporting the oscillation shaft member relative to the article holder, and
the plurality of bearings are spaced apart from each other in the first direction.

4. The article transport vehicle according to claim 1, wherein:
the joint mechanism comprises:
an oscillation shaft member located on the oscillation axis and fixed to the roller support; and
a sliding bearing rotatably supporting the oscillation shaft member relative to the article holder, and
the sliding bearing is in a bearing case supported by the article holder.
